(19) United States
(12) Patent Application Publication
(10) Pub. No.: US 2012/0015174 A1
(43) Pub. Date: Jan. 19, 2012

(54) NOTE PAD CONTAINING CARBONLESS COLOR-DEVELOPING MATERIAL

(75) Inventors: Tsung-Tien KUO, Kaohsiung County (TW); Jen-Rong LIU, Kaohsiung Hsien (TW); Hsien-Min KUO, Kaohsiung City (TW); Tsun-Rung HSU, Kaohsiung County (TW)

(73) Assignee: TAIWAN HOPAX CHEMICALS MFG. CO., LTD., Kaohsiung County (TW)

(21) Appl. No.: 12/912,559

(22) Filed: Oct. 26, 2010

(30) Foreign Application Priority Data
Jul. 13, 2010 (TW) 099122969

(51) Int. Cl. B41M 5/40; B42D 5/00

(52) U.S. Cl. 428/323

(57) ABSTRACT

A note pad includes: a stack of carbonless note sheets each of which includes: a substrate; and a color-developing coating layer formed on an upper surface of the substrate, and including a plurality of microcapsules and a carbonless color-developing material, each of the microcapsules encapsulating a reactive dye and being breakable, when subjected to a pressure, to release the reactive dye to react with the carbonless color-developing material for color development.

### CROSS-REFERENCE TO RELATED APPLICATION

This application claims priority of Taiwanese application no. 099122969, filed on Jul. 13, 2010.

### BACKGROUND OF THE INVENTION

1. Field of the Invention

This invention relates to a note pad, and more particularly to a note pad that includes carbonless note sheets capable of developing an image or mark when a pressure is applied thereon.

2. Description of the Related Art

Referring to FIGS. 1 and 2, a conventional note pad 1 may be used to record a message conveniently using a writing instrument, such as a pencil, pen, mechanical pencil, ballpoint pen, etc. However, it is inconvenient when the pencil or the ink of the pen is used up or no writing instrument is on hand.

### SUMMARY OF THE INVENTION

Therefore, an object of the present invention is to provide a note pad, which can overcome the aforesaid drawbacks associated with the prior art and on which a message may be recorded without using a writing instrument.

According to one aspect of the present invention, there is provided a note pad comprising: a stack of carbonless note sheets each of which includes:

a substrate; and

a color-developing coating layer formed on an upper surface of the substrate, and including a plurality of microcapsules and a carbonless color-developing material, each of the microcapsules encapsulating a reactive dye and being breakable, when subjected to a pressure, to release the reactive dye to react with the carbonless color-developing material and to form colored images.

According to another aspect of the present invention, there is provided a note pad comprising:

a stack of note sheets, the note sheets including a carbonless note sheet and a regular note sheet, the carbonless note sheet including:

a substrate; and

a color-developing coating layer formed on an upper surface of the substrate, and including a plurality of microcapsules and a carbonless color-developing material, each of the microcapsules encapsulating a reactive dye and being breakable, when subjected to a pressure, to release the reactive dye to react with the carbonless color-developing material and to form colored images.

The term “carbonless note sheet” means a sheet containing a carbonless color-developing material.

The term “regular note sheet” means a sheet without a carbonless color-developing material.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a conventional note pad;

FIG. 2 is a side view of the note pad of FIG. 1;

FIG. 3 is a perspective view of the first preferred embodiment of a note pad according to the present invention;

FIG. 4 illustrates that a finger applies a pressure to an upper one of carbonless note sheets in the note pad of FIG. 3;

FIG. 5 illustrates that a mark is created on the upper one of the carbonless note sheets in the note pad of FIG. 4 after application of the pressure;

FIG. 6 is a perspective view of the second preferred embodiment of a note pad according to the present invention; and

FIG. 7 is a cross-sectional view of the note pad of FIG. 6.

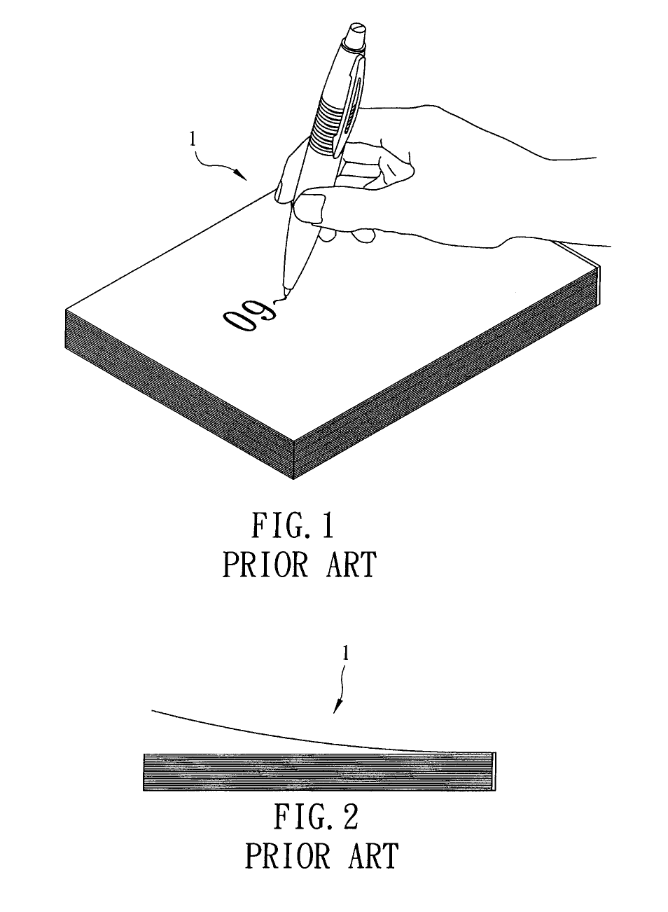

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

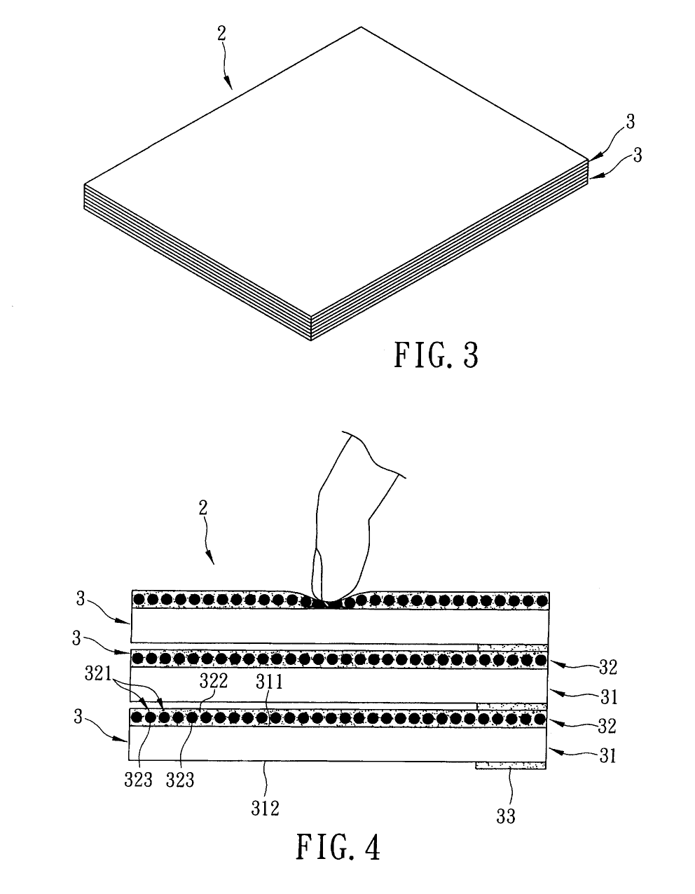

Referring to FIGS. 3 and 4, a note pad 2 according to the first preferred embodiment of the present invention comprises a stack of carbonless note sheets 3. Each of the carbonless note sheets 3 includes a substrate 31, a color-developing coating layer 32, and a first adhesive layer 33. The substrate 31 is made of paper. The color-developing coating layer 32 is coated on an upper surface 311 of the substrate 31. The first adhesive layer 33 is coated on a lateral portion of a back side 312 of the substrate 31. The color-developing coating layer 32 includes a mixture of a plurality of microcapsules 321, which have an average diameter of smaller than 4.5 μm, and a carbonless color-developing material 322. Each of the microcapsules 321 encapsulates a reactive dye and is breakable, when subjected to a pressure, such as a writing pressure, to release the reactive dye to react with the carbonless color-developing material 322 and to form colored images.

Each of the carbonless note sheets 3 is releasably attached to an adjacent one of the carbonless note sheets 3 through the first adhesive layer 33. The first adhesive layer 33 is made of a pressure-sensitive adhesive, and thus, each of the carbonless note sheets 3 may be repositioned to a surface of various articles. The substrate 31 of each of the carbonless note sheets 3 has a basic weight of not less than 60 g/m², and preferably, has a basic weight ranging from 70 g/m² to 120 g/m².

The color-developing coating layer 32 has the microcapsules 321 in an amount that ranges from 0.5 g/m² 5 to 6.0 g/m². Preferably, the color-developing coating layer 32 has the microcapsules 321 in an amount ranging from 1.7 g/m² to 3.0 g/m², and the microcapsules 321 have an average diameter ranging from 2.0 μm to 4.5 μm. Each of the microcapsules 321 includes an outer shell 323 for encapsulating the reactive dye. The outer shell 323 is made of a material selected from aminoplast and gelatin. The reactive dye is crystal violet lactone (CVL). The carbonless color-developing material 322 is selected from phenolic resin, active clay and salicylic type resins.

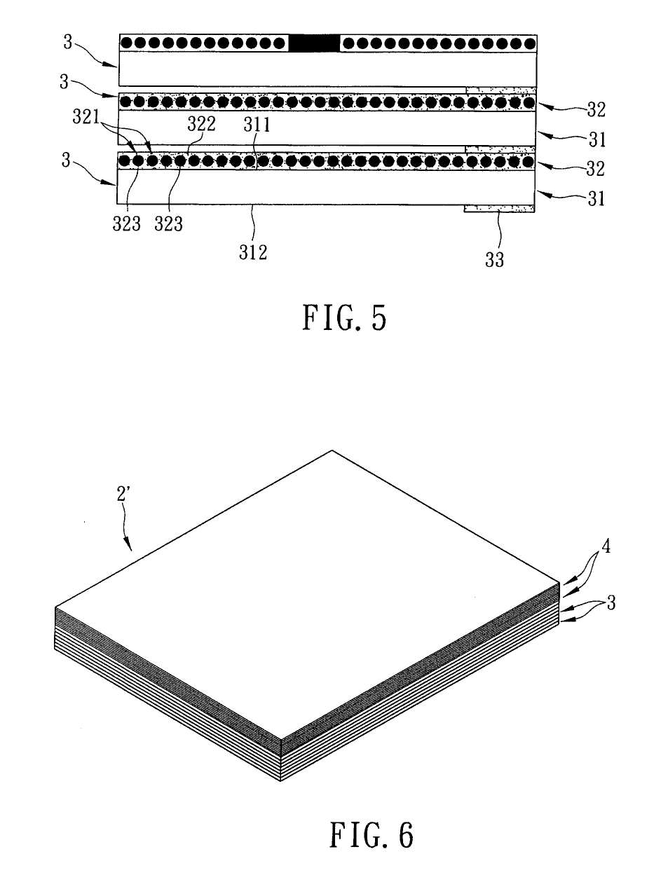

As shown in FIGS. 4 and 5, when a user intends to leave a message on the note pad 2, a writing pressure may be applied to the color-developing coating layer 32 of an upper one of the carbonless note sheets 3. At the point of application of the pressure, the microcapsules 321 will break and release the reactive dye to react with the carbonless color-developing material 322, thereby creating written information on the color-developing coating layer 32. Of course, the writing pressure may be applied using a writing instrument. However, if a writing instrument is unavailable, the user may use his finger, a coin, or any other suitable means that is hard or sharp enough to break the microcapsules 321.

As shown in FIG. 5, when a writing pressure is applied to an upper one of the carbonless note sheets 3, a color is developed only on the upper one of the carbonless note sheets 3, and no significant color is developed on a lower one of the carbonless note sheets 3, which is immediately below the upper one of the carbonless note sheets 3. Such an effect may be achieved by limiting the basic weight of the substrate 31 to one that can disperse and reduce the writing pressure transferred to the lower carbonless note sheet 3. While the carbonless note sheets 3 are disposed in a stack and adhered to each other in this embodiment, the carbonless note sheets 3 may be configured as individual sheets.

### Experiments

The following experiments were conducted with respect to the basic weight of the substrate 31 (Experiment 1), the average diameter of the microcapsules 321 (Experiment 2) and the amount of the microcapsules 321 (Experiment 3).

### Experiment 1

In Experiment 1, five note pads 2 (Examples 1 to 5) were subjected to a typewriter test for evaluating a color developing effect of the carbonless note sheets 3. Details of the typewriter test are disclosed in U.S. Pat. No. 4,087,376. In Experiment 1, each of the note pads 2 has upper and lower carbonless note sheets 3 on which were printed some characters using a dot matrix printer (EPSON LQ-2080C). The color developing effect for each of Examples 1 to 5 was evaluated using an automatic reflectometer (Model TR-600, Tokyo Denshoku K. K.).

In each of Examples 1 to 5, characters were directly printed on the upper carbonless note sheet 3 using a pressure close to that of human writing (i.e., the scale of the printer was set to zero). Furthermore, the substrates 31 of Examples 1 to 5 are all made of paper and respectively have the following basic weights: 40 g/m²; 60 g/m²; 80 g/m²; 100 g/m²; and 120 g/m². In each of Examples 1 to 5, the microcapsules 321 have an average diameter of 2.7 μm, each of which encapsulates crystal violet lactone (CVL). The weight percentage of the microcapsules 321 is 34.10% based on a total weight of a coating material applied to the substrate 31. The amount of the microcapsules 321 in the color-developing coating layer 32 in the examples are expressed in terms of weight per square meter of the color-developing coating layer 32 in Table 1.

After the carbonless note sheets 3 were printed, Hunter Whiteness values (HW values) of the carbonless note sheets 3 in Examples 1 to 5 were measured using the automatic reflectometer for evaluating the color developing effect. In all examples, the HW value of the background (unprinted area) of each carbonless note sheet 3 was about 83. The HW value of the characters on each carbonless note sheet 3 of the Examples is shown in Table 1. The lower the HW value of the characters, the better the color developed in the characters. When the HW value is lower than 70, color development is good. An initial and aged HW value of printed carbonless note sheet 3 was measured within 20 minutes and after 24-hour incubation at room temperature, respectively. As shown in Table 1, when the basic weight of the substrate 31 is not less than 60 g/m², the lower carbonless note sheet 3 does not have significant color development. Therefore, by controlling the basic weight of the substrate 31 to be not less than 60 g/m², only the upper carbonless note sheet 3 will develop good color.

TABLE 1

| Examples | | 1 | 2 | 3 | 4 | 5 |
|---|---|---|---|---|---|---|
| Basic weight (g/m²) | | 40 | 60 | 80 | 100 | 120 |
| M. Amount (g/m²) | | 1.57 | 2.76 | 2.46 | 2.73 | 2.39 |
| Upper Sheet | Initial HW* | 61.1 | 68.9 | 68.1 | 75.3 | 74.9 |
| | Aged HW | 59.4 | 67.3 | 66.9 | 75.1 | 74.6 |
| Lower Sheet | Initial HW | 64.0 | 74.1 | 74.8 | 81.6 | 82.0 |
| | Aged HW | 62.6 | 73.0 | 74.3 | 81.8 | 82.2 |

*M. Amount represents the amount of the microcapsules 321 in the color-developing coating layer 32.
*HW represents Hunter Whiteness value.

### Experiment 2

In Experiment 2, a static pressure test was conducted on each carbonless note sheet 31 for evaluating whether or not the carbonless note sheet 31 is stainable easily by accidental pressure such as rubbing or hitting force. The static pressure test was conducted by: (a) measuring a first HW value of the carbonless note sheet 31 before a static pressure is applied to the carbonless note sheet 31 for one minute, (b) measuring a second HW value of the carbonless note sheet 31 after application of the static pressure, and (c) obtaining a HW difference between the first and second HW values. The first and second HW values were obtained using the automatic reflectometer. In Examples 6 to 11, the weight percentage of the microcapsules 321 in the coating material of the color-developing coating layer 32 was 34.10%. The amounts and average diameters of the microcapsules 321 were varied in Examples 6 to 11 as shown in Table 2. The substrates 31 in Examples 6 to 11 are made of paper and have a basic weight of 80 g/m².

Referring to Table 2, the HW difference is a negative value. The closer the negative value to zero, and the lower the stainability of the carbonless note sheet 3 will be. The smaller the HW difference, the higher the stainability will be. When the HW difference is less than −2, the stainability of the carbonless note sheet 31 is not low but still acceptable. When the HW difference is less than −6, the stainability of the carbonless note sheet 31 is significantly high. According to the results of Table 2, the larger the diameter of the microcapsules 321, the smaller the HW difference will be. In other words, the smaller the microcapsules 321, the lower the chance of the microcapsules 321 to break easily. Preferably, the average diameter of the microcapsules 321 is less than 4.5 μm, more preferably less than 3.5 μm, and most preferably less than 2.8 μm.

TABLE 2

| Examples | 6 | 7 | 8 | 9 | 10 | 11 |
|---|---|---|---|---|---|---|
| Diameter | 2.144 | 2.740 | 3.574 | 4.467 | 5.269 | 6.262 |
| (μm) | | | | | | |
| M. amount | 1.74 | 2.01 | 1.91 | 1.94 | 1.81 | 1.94 |
| (g/m²) | | | | | | |
| HW | −0.49 | −1.01 | −4.68 | −4.57 | −4.56 | −5.97 |
| difference | | | | | | |
| under | | | | | | |
| 5 kgf/cm² | | | | | | |
| HW | −0.61 | −1.45 | −5.1 | −5.2 | −6.15 | −6.66 |
| difference | | | | | | |
| under | | | | | | |
| 7 kgf/cm² | | | | | | |

### Experiment 3

In Examples 12 to 20, the color-developing coating layers 32 were formed from coating materials containing different percentages of the microcapsules 321 as shown in Table 3. The substrates 31 of the examples have a basic weight of 80 g/m².

Examples 12 to 20 were tested using the typewriter test and the static pressure test. The test results are shown in Table 3. The background (unprinted area) of each carbonless note sheet 3 in Examples 12 to 20 has the HW value of about 83.

As shown in Table 3, when the weight percentage of the microcapsules 321 is lower than 30%, the upper carbonless note sheets 3 of the examples have poor color development. When the weight percentage of the microcapsules 321 is higher than 50%, the lower carbonless note sheets 3 of the examples have significant color development. On the other hand, when the weight percentage of the microcapsules 321 in the coating material is higher than 50%, the HW difference under the static pressure of 7 kgf/c/m² is less than −2, and the stainability is significant. Accordingly, the weight percentage of the microcapsules 321 in the coating material preferably ranges from 30% to 50%. Through a conversion calculation of the aforesaid range of the percentage, the amount of the microcapsules 321 in the color-developing coating layer 32 ranges from 1.7 g/m² to 3.0 g/m².

TABLE 3

| Examples | | 12 | 13 | 14 | 15 | 16 | 17 | 18 | 19 | 20 |
|---|---|---|---|---|---|---|---|---|---|---|
| Percentage (%) | | 5 | 10 | 20 | 30 | 40 | 50 | 60 | 70 | 80 |
| M. amount | | 0.31 | 0.57 | 1.26 | 1.77 | 2.40 | 2.70 | 3.54 | 3.57 | 4.64 |
| (g/m²) | | | | | | | | | | |
| Upper | Initial | 77.5 | 75.5 | 71.5 | 66.1 | 64.4 | 61.7 | 60.4 | 60.1 | 55.2 |
| sheet | HW | | | | | | | | | |
| | Aged | 76.8 | 74.8 | 70.3 | 65.1 | 63.2 | 60.2 | 57.4 | 58.3 | 54.6 |
| | HW* | | | | | | | | | |
| Lower | Initial | 77.9 | 77.5 | 76.0 | 73.1 | 71.8 | 70.0 | 68.3 | 69.2 | 65.1 |
| sheet | HW | | | | | | | | | |
| | Aged | 77.7 | 77.2 | 75.6 | 72.7 | 71.2 | 69.2 | 66.4 | 67.3 | 64.7 |
| | HW* | | | | | | | | | |

| | | | | | | | | | |
|---|---|---|---|---|---|---|---|---|---|
| HW difference | 0 | −0.22 | −0.29 | −0.23 | −0.69 | −0.47 | −1.60 | −1.65 | −1.98 |
| (under 5 kgf/cm²) | | | | | | | | | |
| HW difference | −0.05 | −0.26 | −0.71 | −1.08 | −1.79 | −1.75 | −3.0 | −3.45 | −3.85 |
| (under 7 kgf/cm²) | | | | | | | | | |

*The aged HW value of printed carbonless note sheets 3 was measured after 3-hour incubation at room temperature.

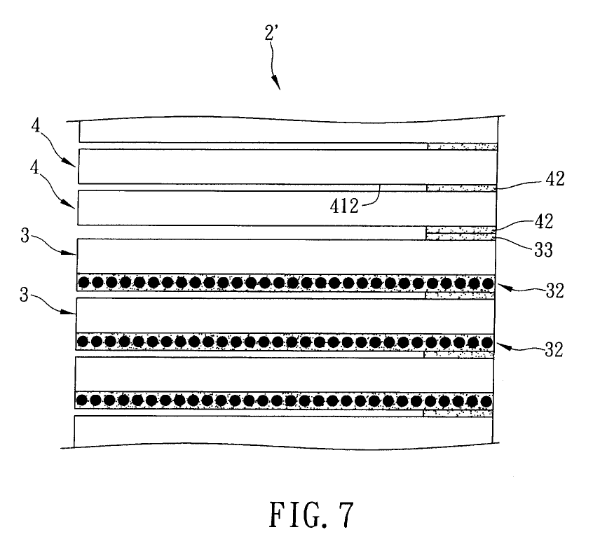

FIGS. 6 and 7 illustrate a note pad 2′ according to the second preferred embodiment of the present invention. The second preferred embodiment differs from the first preferred embodiment only in that the note pad 2′ further comprises a stack of regular note sheets 4. The stack of the regular note sheets 4 and the stack of the carbonless note sheets 3 are arranged in a single stack. Each of the regular note sheets 4 has a back side 412 formed with a second adhesive layer 42 made of a pressure-sensitive adhesive. One of the carbonless note sheets 3 is adhered to an adjacent one of the regular note sheets 4 through the first and second adhesive layers 33, 42, and the remaining of the regular note sheets 4 are adhered to each other through the second adhesive layers 42.

With the use of the note pad 2′ according to the present invention, the user may write down a message on the regular note sheets 4 using a writing instrument. When no writing instrument is on hand, the user may apply a pressure on the carbonless note sheets 3 using his finger or a suitable means to record a message.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A note pad comprising:
a stack of carbonless note sheets each of which includes:
a substrate; and
a color-developing coating layer formed on an upper surface of said substrate, and including a plurality of microcapsules and a carbonless color-developing material, each of said microcapsules encapsulating a reactive dye and being breakable, when subject to a pressure, to release said reactive dye to react with said carbonless color-developing material and to form colored images.

2. The note pad of claim 1, wherein each of said carbonless note sheets develops a color having a HW value of less than 70 when subjected to a pressure that is exerted directly thereon, and each of said carbonless note sheets does not develop a color having a HW value of less than 70 when an upper one of said carbonless note sheets which lies immediately thereover is subjected to said pressure.

3. The note pad of claim 1, wherein said substrate is made of paper and has a basic weight of not less than 60 g/m².

4. The note pad of claim 3, wherein said substrate has a basic weight ranging from 70 g/m² to 120 g/m².

5. The note pad of claim 1, wherein said microcapsules have an average diameter of smaller than 4.5 μm.

6. The note pad of claim 1, wherein said color-developing coating layer has said microcapsules in an amount that ranges from 0.5 g/m² to 6.0 g/m².

7. The note pad of claim 1, wherein said color-developing coating layer has said microcapsules in an amount ranging from 1.7 g/m² to 3.0 g/m².

8. The note pad of claim 1, wherein said substrate of each of said carbonless note sheets has a back side coated with a first adhesive layer, and each of said carbonless note sheets is releasably attached to an adjacent one of said carbonless note sheets through said first adhesive layer.

9. The note pad of claim 8, further comprising a stack of regular note sheets, said stack of said regular note sheets and said stack of said carbonless note sheets being arranged in a single stack, each of said regular note sheets having a back side formed with a second adhesive layer, one of said carbonless note sheets being adhered to an adjacent one of said regular note sheets through at least one of said first and second adhesive layers, the remaining of said regular note sheets being adhered to each other through said second adhesive layers.

10. The note pad of claim 9, wherein each of said first and second adhesive layers is made of a pressure-sensitive adhesive.

11. The note pad of claim 1, wherein said microcapsules have an average diameter ranging from 2.0 μm to 3.5 μm.

12. The note pad of claim 11, wherein said microcapsules have an average diameter ranging from 2.0 μm to 2.8 μm.

13. The note pad of claim 1, wherein each of said microcapsules includes an outer shell encapsulating said reactive dye.

14. The note pad of claim 13, wherein said outer shell is made of a material selected from aminoplast and gelatin, and said reactive dye is crystal violet lactone.

15. The note pad of claim 1, wherein said carbonless color-developing material is selected from phenolic resin, active clay and salicylic type resins.

16. A note pad comprising;
a stack of note sheets, said note sheets including a carbonless note sheet and a regular note sheet, said carbonless note sheet including:
a substrate; and
a color-developing coating layer formed on an upper surface of said substrate, and including a plurality of microcapsules and a carbonless color-developing material, each of said microcapsules encapsulating a reactive dye and being breakable, when subjected to a pressure, to release said reactive dye to react with said carbonless color-developing material and to form colored images.

17. The note pad of claim 16, wherein said substrate is made of paper and has a basic weight of not less than 60 g/m², and said microcapsules have an average diameter of less than 4.5 μm.
